(19) United States
(12) Patent Application Publication
(10) Pub. No.: US 2008/0157416 A1
(43) Pub. Date: Jul. 3, 2008

(54) Method of Producing a Low Haze Plastic Glazing

(76) Inventors: Barry Hoult, Duncan, SC (US); Harold Mukamal, Laguna Woods, CA (US); Chengtao Li, Novi, MI (US); Keith D. Weiss, Fenton, MI (US)

Correspondence Address: BRINKS HOFER GILSON & LIONE, P.O. BOX 10395, CHICAGO, IL, 60610, US

(21) Appl. No.: 11/749,477

(22) Filed: May 16, 2007

Related U.S. Application Data
(60) Provisional application No. 60/877,360, filed on Dec. 27, 2006.

(51) Int. Cl. B28B 7/38

(52) U.S. Cl. 264/39

(57) ABSTRACT

A method of manufacturing low-haze plastic window glazing is claimed where a portion of a panel mold interior is polished with an abrasive material no finer than 600 grit size. Plastic resin is then introduced into the mold under heat and pressure to form a panel. Weatherable coating is then applied to portions of the panel via a wet coating process. An abrasion resistant coating is then applied to portions of the panel via a plasma application technique. This method produces a window glazing with at least one portion having no more than 1% haze.

### CROSS-REFERENCE TO RELATED APPLICATIONS

This application claims the benefit of U.S. Provisional Application Ser. No. 60/877,360, filed on Dec. 27, 2006, entitled “Method of Producing a Low Haze Plastic Glazing,” the entire contents of which are incorporated herein by reference.

### BACKGROUND OF THE INVENTION

This invention concerns plastic glazing, particularly for automotive window panels.

It has long been proposed to construct windows for automotive vehicles from synthetic resins, i.e., from plastic material such as polycarbonate and polymethylmethyacrylate to name just two. Molded plastic automotive windows offer a number of advantages over conventional glass glazing, including improved vehicle safety. Polycarbonate panels better resist shattering as compared to glass and, in a crash, are better than existing glass windows in keeping occupants contained within the vehicle. Lighter windows may also facilitate a lower center of gravity for the vehicle, contributing to better vehicle handling and safety. Further, plastic windows afford greater design freedom due to the ease in forming complex curved shapes, and allow the automotive manufacturer to integrate functional components such as lighting lenses and light fixture mounts into a window assembly, thereby further reducing weight, materials, and assembly costs. Further, plastic materials, being lighter than glass, enable higher fuel efficiencies.

Although there are many advantages associated with implementing plastic windows, plastic windows have limitations that represent technical hurdles which must be addressed prior to wide-scale commercial utilization. Limitations relating to material properties include the stability of plastics to prolonged exposure to elevated temperatures, deterioration due to sunlight and harsh weather conditions, and susceptibility to scratches and abrasions. Fortunately, by hard coating the plastic surface by processes heretofore developed, sufficient scratch resistance can be achieved to produce automotive windows performing well in service. Other coatings, such as UV-blocking coatings, further improve the performance of plastic windows for automotive vehicles.

Another significant technical hurdle is achieving optical clarity comparable to glass. The initial plastic panel, such as polycarbonate panels used in automotive glazing, is typically manufactured using injection molding techniques. The clarity of a panel produced from such molds is largely determined by the smoothness of the planer surface of the panel, which in turn is largely determined by the smoothness of the mold cavity. The rougher the mold surface, the rougher the surface of the plastic panel and the higher the optical distortion, or haze, in the panel.

In order to reduce haze below 1%, which is desirable for glazing in many applications including automotive applications, manufacturers have commonly. polished injection molding tools using successively finer abrasives to obtain a very smooth mold surface. The fine abrasives used to achieve these very smooth mold surfaces are typically 1000 grit or higher (with higher grit value corresponding to finer abrasives), with extremely small abrasive particles of 6 micrometers or smaller employed in some applications. However, achieving an extremely smooth mold surface finish is expensive and often involves longer lead times for mold fabrication. Further, highly polished molds can introduce complications related to the release of the plastic panel from the mold, complicate the adhesion of ink or other coatings on the panel surface, and cause surface defects when used in combination with in-mold decorations fabricated into the panels.

Therefore, there is a need in the industry for a method of producing plastic glazing having acceptably low optical haze while reducing the cost and other problems associated with polishing molds to an extremely smooth finish.

### SUMMARY OF THE INVENTION

The present invention is a method of producing plastic glazing having less than 1% haze without polishing the mold interior to the degree of smoothness previously thought necessary to achieve this optical quality. By controlling the compositions of coatings applied to the panel, the order in which those coatings are applied, and the methods of applying those coatings, a plastic window glazing having less than 1% haze can be produced from molds polished with an abrasive material no finer than 600 grit size.

In one embodiment, the present invention provides a method of manufacturing plastic window glazing comprising providing a panel mold having an interior cavity and polishing a portion of that panel mold interior with an abrasive material no finer than 600 grit size. The method further includes the steps of introducing plastic resin into the panel mold under heat and pressure, removing a panel from the mold, applying a wet coat of weatherable coating to a portion of the panel, then applying an abrasion resistant coating to a portion of the panel via plasma-ion application techniques. This method produces a window glazing with at least one coated portion having no more than 1% haze.

Other features and advantages of the invention will be apparent from the following detailed description and the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a simplified perspective of a two-part mold for injection molded plastic panels and a resulting panel;

FIG. 2 is a cross section of the assembled mold of FIG. 1 illustrating the mold cavity;

FIG. 2a is an enlarged view of a portion of the assembled mold, generally enclosed by circle 2a in FIG. 2;

FIG. 3 is a schematic flow chart illustrating a method of producing a plastic glazing using a mold polished with an abrasive having a grit no finer than 600 and producing a glazing with less than 1% haze; and

FIG. 4 is a schematic flow chart illustrating a method of producing a polycarbonate glazing having less than 1% haze suitable for use as a sunroof in an automotive vehicle.

### DETAILED DESCRIPTION OF THE INVENTION

The following description of the preferred embodiment is merely exemplary in nature and is in no way intended to limit the invention or its application or uses.

The present invention provides a detailed specification of a method and parameters enabling production of a plastic glazing having less than 1% haze using a mold polished with an abrasive material having a grit grade no finer than 600. The relative coarseness of this grade of grit produces a panel that initially has haze values substantially higher than 1%. The inventors have determined that application of a wet coat of a weather protective coating planarizes the surface of the plastic. If the mold surface is polished with a grit finer than 1000 grit size, e.g., 1400 grit or 6 micrometer particle size, then optical distortion in the molded parts actually increases following application of the wet coat. This result is counterintuitive, for it indicates that polishing the mold to high levels of smoothness may promote optical distortion in glazing that receives a wet coat of weather resistant coating.

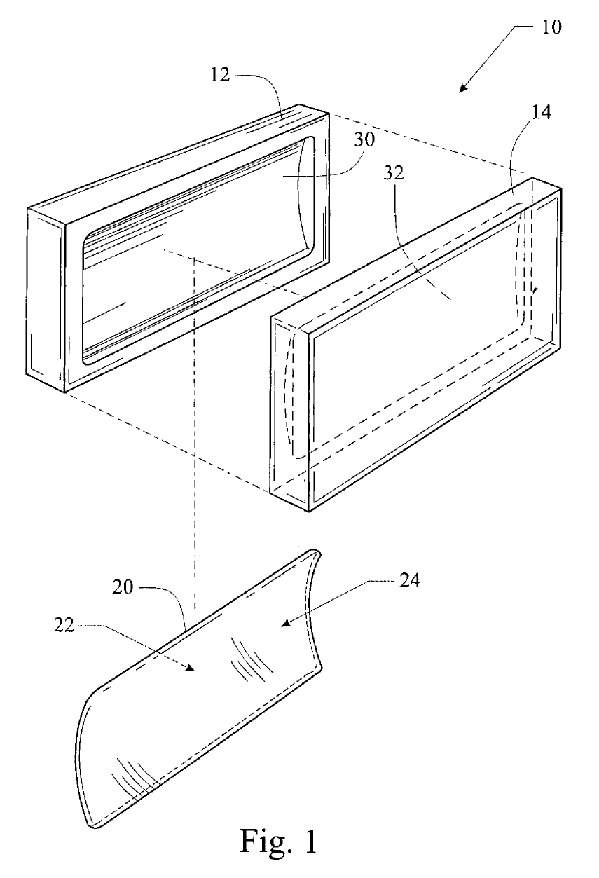

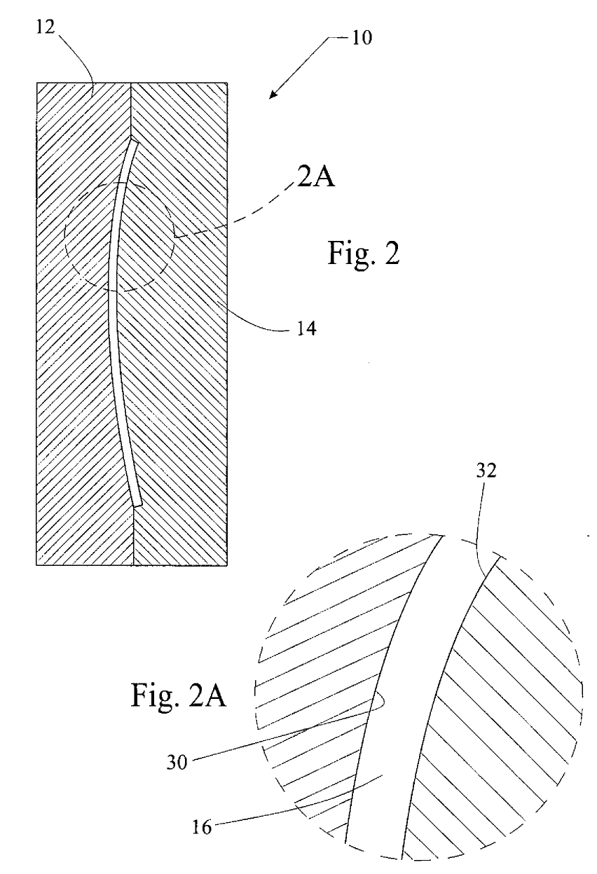

FIG. 1 depicts a simplified perspective of an injection mold apparatus used in the inventors' method for producing low-haze plastic glazing. FIG. 2 depicts a simplified cross section of the assembled mold. Referring to FIGS. 1 and 2, a panel mold 10 is shown having a first mold half 12 and a second mold half 14, which when joined together define a mold cavity 16 into which a plastic resin can be introduced. A panel 20 is then produced by injecting the resin at an appropriate heat and pressure. The inventors contemplate that panel 20 would be formed using injection molding techniques; however, the panel could also be formed through other plastic molding techniques known to those skilled in the art, such as blow molding and compression molding and/or thermoforming, the latter including thermal forming, vacuum forming, and cold forming. Although not necessary, the aforementioned techniques may be used in combination with each other, such as thermoforming a transparent plastic top layer into the shape of one inside surface of a mold prior to injection molding a base layer onto and integrally bonding with the top layer, thereby, forming a transparent plastic panel 20 with the desired shape.

In many applications including automotive vehicles, it is highly desirable to produce a panel 20 with low haze and low optical distortion. In order to achieve less than 1% haze levels, the interior surfaces of the mold 30 and 32 must be polished with an abrasive in order to create a smooth surface from which the plastic panel surface is formed. In order for panel 20 to have less than 1% haze fresh from the mold, interior surfaces 30 and 32 must be highly polished in multiple steps with successively finer abrasives concluding with a grit size of 1400, or perhaps an even finer grit of 6 micrometer particle size. The method of the present invention, in contrast, comprises applying a final polish to mold surfaces 30 and 32 with a substantially coarser grit no finer than 600 grit size. Although the raw plastic glazing 20 produced by molds polished at this level will have a haze of approximately 2% or higher, the inventors have found that applying a wet coat of a silicone-based hard coat (not shown) not only improves resistance to weather and ultraviolet degradation of the plastic, but also improves the surface characteristics of panel surfaces 22 and 24 to which the coating is applied. This improvement is achieved through a planarizing effect, thereby reducing unwanted variability of short wavelength light. This wet coat thus reduces haze from the levels observed in a raw panel 20.

In addition to being more susceptible to UV degradation, plastics are generally more susceptible to scratches and abrasion than glass. In order to protect them from unwanted scratches and abrasion, it is known to apply an abrasion resistant coating to panel surfaces 22 and 24 via a plasma-ion assisted application. Although the plasma coat protects against scratches and other unwanted abrasion, it also introduces optical distortion into the panel. Regardless of whether the panel surface has been subjected to a weather resistant wet coat, in order to achieve less than 1% haze in the final glazing, the panel must have significantly less than 1% haze prior to the step of applying an abrasion resistant plasma coat.

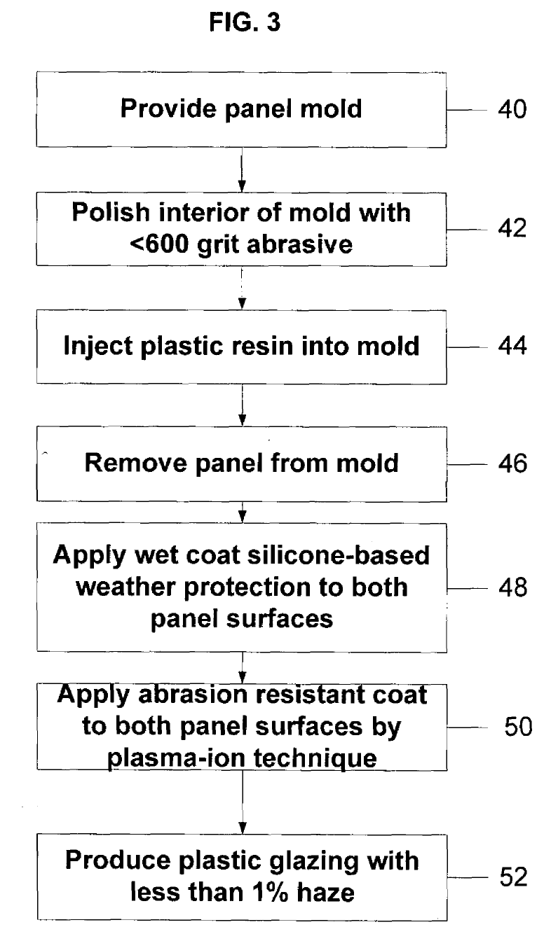

FIG. 3, in conjunction with FIGS. 1 and 2, illustrates the steps involved in one preferred embodiment of the invention as described above. In the first step 40, a panel mold 10 for injection-molded plastic panels is provided. In step 42 the interior surfaces 30 and 32 of panel mold 10 are polished in successively finer grades with the final abrasive grade being no finer than 600. In step 44, a plastic resin (not shown) is then injected into the polished mold cavity 16 to form a panel under heat and pressure. The panel 20 is removed from mold 10 in step 46. This raw panel will have haze values on the order of 2-3% which is unsatisfactory for many applications, including use in automotive vehicles.

A next step 48 comprises applying a wet coat of weather resistant material to both panel surfaces. The weathering layer preferably comprises either a polyurethane coating or a combination of an acrylic primer and a silicone hard-coat. Alternatively, other coating systems may be used. An example of such an acrylic primer includes Exatec® SHP 9X, which is commercially available from Exatec, LLC (Wixom, Mich.) and distributed by General Electric Silicones (Waterford, N.Y.). In one preferred embodiment, the primer is coated on the transparent plastic panel 20, air dried, and then thermally cured between about 80° C. and 130° C. for between about 20 to 80 minutes and more preferably at about 120° C. for about 60 minutes. A silicone hard-coat is then applied over the primer layer and is air dried before curing at preferably between about 80° C. and 130° C. for between about 20 to 80 minutes and more preferably at about 100° C. for about 30 minutes. A preferred silicone hard-coat used in the present invention is available from Exatec, LLC and distributed by General Electric Silicones as Exatec® SHX.

In a preferred embodiment of the present invention, the primer in the weathering layer is a waterborne acrylic primer comprising water as the first co-solvent and an organic liquid as a second co-solvent. The general chemical classes associated with the second co-solvent present in the primer/hard-coat system includes glycol ethers, ketones, alcohols and acetates. The acrylic resin may be present as a water soluble, dispersible, or reducible resin. The primer may contain other additives, such as, but not limited to, surfactants, antioxidants, biocides, ultraviolet absorbers (UVAs), and drying agents, among others.

The resin in the silicone hard-coat is preferably a methylsilsequioxane resin dispersed in a mixture of alcohol solvents. The silicone hard-coat may also comprise other additives, such as but not limited to surfactants, antioxidants, biocides, ultraviolet absorbers, and drying agents, among others.

The weathering layer may be applied to the transparent plastic panel by dipping the panel in the coating at room temperature and atmospheric pressure through a process known to those skilled in the art as dip coating. Alternatively, the weathering layer may be applied by flow coating, curtain coating, spray coating, or other processes known to those skilled in the art.

After drying, the haze on the portions of panel 20 to which the silicone-based hard coat has been applied on both sides will typically be less than 0.5% due to the tendency of the wet coat to planarize the panel surface.

The next step 50 comprises applying a substantially inorganic coating as an abrasion resistant coating to both panel surfaces 22 and 24 using a plasma assisted application process on top of the wet coat weathering layer. Specific examples of possible inorganic coatings comprising the abrasion resistant layer include, but are not limited to, aluminium oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon oxy-carbide, silicon carbide, hydrogenated silicon oxy-carbide, tantalum oxide, titanium oxide, tin oxide, indium tin oxide, yttrium oxide, zinc oxide, zinc selenide, zinc sulfide, zirconium oxide, zirconium titanate, or glass, and mixtures or blends thereof. Preferably, the abrasion resistant layer is applied by plasma enhanced chemical vapor deposition (PECVD), arc-PECVD, or ion assisted plasma deposition. Although step 50 may introduce optical distortion into the panel, the overall haze of a plastic glazing produced in final step 52 will still be less than 1% after the plasma coat.

A manufacturer may wish to omit the wet coat of UV resistant coating to save coating expenses, particularly if one of the panel surfaces is ordinarily shielded from significant ultraviolet radiation. In another embodiment of the invention, a glazing having less than 1% haze is produced having a wet coat applied to only one panel surface. Due to the planarizing effects of the weatherable wet coat, the mold surface producing that panel surface need not be highly polished but may be polished to a smoothness obtainable with a relatively coarse grit no finer than 600 grit size. For the panel surfaces that do not receive a weatherable wet coat, however, the mold surface producing that panel's surface is polished to a very high level, using at least 1400 grit abrasive.

Referring again to FIG. 1 and FIG. 2, panel 20 has first panel surface 22 and second panel surface 24. In some applications, it is desirable to protect only one panel surface from both abrasion and from weather effects, such as ultraviolet light, which tends to degrade plastic. For example, if first panel surface 22 is the exterior surface of a sunroof of an automotive vehicle, it is desirable to apply a weather resistant coating to first panel surface 22, but protecting the interior surface of the sunroof panel 24 from weather and ultraviolet rays may not be necessary. However, scratch and abrasion resistance, through a plasma coating application or other process, will usually be desirable on both panel surfaces 22 and 24.

To produce such a panel and referring to FIG. 1, first mold half 12 comprises a first interior mold surface 30 which will form first (exterior) panel surface 22. Second mold half has interior mold surface 32 which will form second (interior) panel surface 24. To produce a plastic automotive glazing that will have a weather resistant coating only on the first panel surface 22 and an abrasion resistant plasma coating on both the panel surfaces 22 and 24, according to the current method, first interior mold surface 30 is polished with an abrasive no finer than 600 grit size and second interior mold surface 32 is polished with an abrasive at least as fine as 1400 grit size. The first molded panel surface 22 resulting from this method will be significantly rougher and have a higher haze percentage than panel surface 24, which will have a haze value below 1% due to the highly polished mold interior 32. In the next step of the current method, a wet coat of a silicone-based weather protective coating is applied to the first panel surface 22. This step will tend to smooth and planarize panel surface 22 and reduce haze below 1%. In the next step of the current method, an abrasion resistant coating is applied to both the first panel surface 22 and to the second panel surface 24. Under this method, a glazing is produced having overall haze less than 1%.

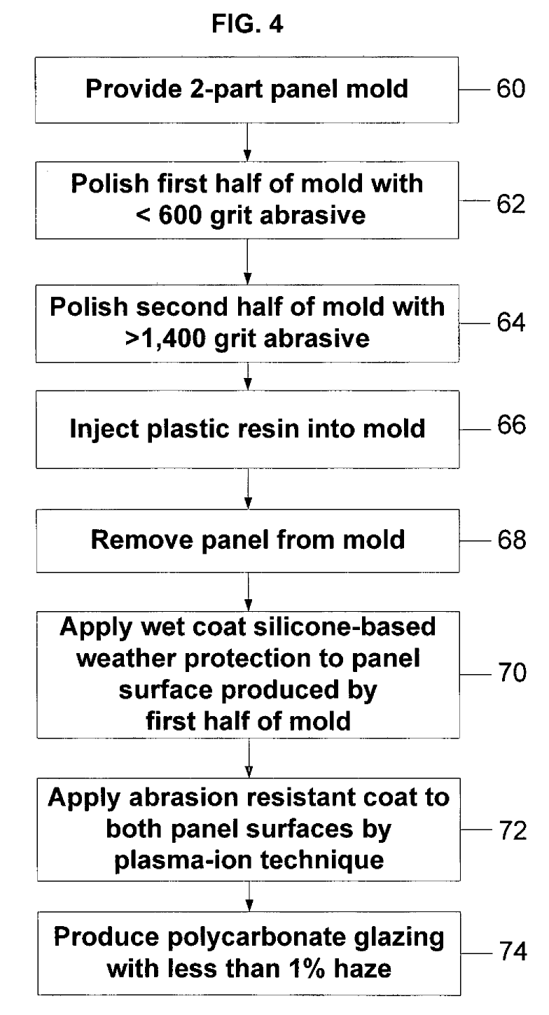

FIG. 4, in conjunction with FIGS. 1 and 2, illustrates the steps involved in a preferred embodiment of the invention just described. In the first step 60, a panel mold 10 for injection-molded plastic panels is provided. In the next step, step 62, the interior of first half of the panel mold 30 is polished in successively finer grades with the final abrasive grade being no finer than 600. In step 64, the interior of second half of the panel mold 32 is polished in successively finer grades with the final abrasive grade being at least as fine as 1400 grade thereby producing a highly polished surface. In step 66, a plastic resin (not shown) is injected into the mold cavity 16 to form a panel 20 under heat and pressure. This panel 20 is removed from the mold 10 in step 68. Because only one half of the panel mold interior was highly polished, this raw panel will have haze values that exceed 1%. In the next step, step 70, comprises applying a wet coat of weather resistant silicone-based hard coating material to the rougher panel surface 22 produced by first half mold surface 30. In this embodiment, the wet coat silicone-based weather protection is not applied to the smooth panel surface 24 which was produced by second half mold surface 32. This panel surface 24 would thus not have the same level of protection against ultraviolet degradation. The next step 72 comprises applying an abrasion resistant coating to both panel surfaces 22 and 24 using a plasma assisted application process as described above. This step 72 introduces optical distortion into panel 20, but the overall haze of the polycarbonate glazing produced in step 74 will still be less than 1% after the plasma coating is applied in step 72.

The inventors contemplate that the plastic resin used in this process is preferably a polycarbonate material; however, the method may be productively applied to polymethylmethyacrylate or other plastics including, but not limited to acrylic, polyarylate, polyester and polysulfone resins, as well as copolymers and mixtures thereof. Preferably, the transparent plastic panel includes bisphenol-A polycarbonate and all other resin grades (such as branched or substituted), as well as being copolymerized or blended with other polymers such as PBT, ABS, or polyethylene. The plastic panel may further be comprised of various additives, such as colorants, mold release agents, antioxidants, and ultraviolet absorbers (UVAs), among others.

As a person skilled in the art will readily appreciate, the above description is meant as an illustration of implementation of the principals of this invention. This description is not intended to limit the scope or application of this invention in that the invention is susceptible to modification, variation and change, without departing from the spirit of this invention, as defined in the following claims.

1. A method of manufacturing plastic window glazing comprising the steps of:
providing a panel mold having interior cavity defined by at least a first cavity surface and a second cavity surface;
polishing at least the first cavity surface of the panel mold with an abrasive material no finer than 600 grit size;
introducing plastic resin into the panel mold under heat and pressure to form a panel having first and second panel surfaces respectively corresponding to the first and second cavity surfaces;
removing the panel from the panel mold;
applying a weather resistant coating to at least the first panel surface; and
resulting in a window glazing having no more than one percent haze.

2. The method of claim 1 where the step of introducing the plastic resin comprises injecting a polycarbonate based resin.

3. The method of claim 1 where the step of applying of the weather resistant coating is a wet coating process.

4. The method of claim 3 where the step of applying of the weather resistant coating applies a silicone hard coat.

5. The method of claim 1 where the polishing step is performed only on the first cavity surface.

6. The method of claim 1 where the step of applying the weather resistant coating only applies the coating to the first panel surface.

7. The method of claim 1 further comprising the step of polishing the second cavity surface with an abrasive material at least as fine as 1,400 grit size.

8. The method of claim 1 further comprising applying an abrasion resistant coating over at least the first panel surface.

9. The method of claim 1 wherein the polishing step polishes both the first and second cavity surfaces.

10. The method of claim 9 wherein the step of applying the weather resistant coating applies the coating to both the first and second panel surfaces.

11. The method of claim 10 further comprising applying an abrasion resistant coating over the first and second panel surfaces.

12. A method of manufacturing polycarbonate window glazing for use in an automotive vehicle comprising the steps of:
providing a panel mold having an interior cavity;
polishing the interior of the panel mold with an abrasive material no finer than 600 grit size;
injecting a polycarbonate resin into the panel mold under heat and pressure;
removing a panel from the panel mold;
applying a wet coat of silicone based weatherable coating to both sides of the panel;
applying an abrasion resistant coating by plasma-ion application technique to both sides of the panel;
producing a window glazing having no more than one percent haze over substantially the entire panel; and
installing the glazing in an automotive vehicle.

13. A method of manufacturing polycarbonate window glazing for use as a sunroof in an automotive vehicle comprising the steps of:
providing a panel mold comprised of a first half and a second half which when assembled has an interior cavity;
polishing the interior of the first mold half with an abrasive material no finer than 600 grit size;
polishing the interior of the second mold half with an abrasive material at least as fine as 1,400 grit size;
injecting a polycarbonate resin into the panel mold under heat and pressure;
removing a panel from the panel mold;
applying a wet coat of silicone-based weatherable coating only to the panel surface formed by the first mold half;
applying an abrasion resistant coating by plasma-ion application technique to the panel surfaces produced by the first mold half and the second mold half;
producing a window glazing having no more than one percent haze over substantially the entire panel; and
installing the glazing as a sunroof in an automotive vehicle.
